(19) United States
(12) Patent Application Publication
(10) Pub. No.: US 2024/0016121 A1
(43) Pub. Date: Jan. 18, 2024

(54) TREAT MAZE INTERACTIVE PET TOY BALL

(71) Applicant: Graham Geil Wilson, Denver, CO (US)

(72) Inventor: Graham Geil Wilson, Denver, CO (US)

(21) Appl. No.: 17/867,429

(22) Filed: Jul. 18, 2022

(51) Int. Cl. A01K 15/02

(52) U.S. Cl. CPC A01K 15/025

(57) ABSTRACT

The invention is a clear plastic ball with treat maze sections sonic welded together on an x axis with holes for tennis balls filled with treats to travel though when a pet manipulates the ball. Tennis balls and treats can move through apertures in the connected treat mazes so the pet can solve the puzzle and obtain treats. A giggler is located on an internal center shaft which is not moveable but will “giggle” when the toy is manipulated.

### FIELD

The present invention relates generally to stimulating, encouraging and motivating games and methods of playing regarding pets, e.g. dogs and cats. More particularly, the invention relates to motivational games, toys and methods for interacting with pets and providing exercise and learning thought treat reward at the same time.

### PRIOR ART

There are many types of pet toys on the market that squeak or dispense treats in a fairly simple fashion. This novel toy is a round clear plastic ball with circular maze pieces affixed inside the clear outer ball wherein holes in the maze pieces allow a treat filled tennis balls to travel through the holes therein and ultimately have the pet release the ball through any hole and retrieve a tennis ball with treats inside. The toy also contains a giggle apparatus which is heat sealed to the mase pieces and will make a “giggling” sound which further entices the pet to try to obtain whatever it perceives to be a prize.

### BRIEF DESCRIPTION OF THE INVENTION

Two maze pieces are arranged on an x axis and heat welded to one another so they may roll about inside the clear shell, but will remain affixed to one another on that x axis.

The object of the present invention is to motivate and maintain interest of a pet, as well as challenge the pet's memory skills in terms of recalling how and where it obtained the treats in this toy from.

Veterinarians caution pet owners about using the right kind of toy especially when the pet will be left alone for time periods. The toy should be durable, and not contain small pieces easily swallowed, yet still provide that action of having to get the balls out of the toy to play with. The inventive toy meets that criteria as well as providing the stimuli that will keep a dog interested in the toy, and hopefully not so interested in the couch.

### BACKGROUND OF THE INVENTION

The invention most closely corresponds with USPTO Class 119/707 wherein Class 119 relates to animal husbandry and sub-class 707 includes toys.

In its simplest form, the invention relates to a novel toy for pets wherein a clear ball allows a pet to see structure within as well as smell treats that may be inside the tennis balls which were inserted. Two maze pieces are welded together on an x axis and contain holes for tennis balls to travel through upon manipulation of the toy by the pet. The movement has to be just right to allow gravity to release a tennis ball from a hole in the outer ball shell.

### THE INVENTION

### Summary, Objects and Advantages

It well known that pets do experience a sense of boredom, and if not addressed, may manifest in negative behavior such as chewing furniture or going to the bathroom in undesirable locations in the pet owner's home. When presented with a toy that makes a high-pitched squeaky noise, many dogs will revert to a stylized version of the shake and kill pattern of their wild ancestors. Having a toy that merely squeaks is a positive step, but having a toy where the dog can actually be rewarded by getting something “out” adds significant stimulation. The dog can continue to play with the balls until its owner re-stuffs the toy and the dog gets to repeat the behavior.

### BRIEF DESCRIPTION OF THE DRAWINGS

The invention is described in further detail by reference to eight (8) drawings sufficient in detail to describe the invention in which:

FIG. 1 is a head-on view of the ball toy showing one maze piece in full and the giggler center section;

FIG. 2 is a ball shown opaque and in phantom to illustrate connection;

FIG. 3 is a view of the giggler;

FIG. 4 a top-down view of one of the maze pieces showing the 3 ball holes;

FIG. 5 is a view of the other maze piece with 2 holes, the aperture for inserting tennis balls, and the giggler;

FIG. 6 is a view of the tennis ball for spatial relation;

FIG. 7 is a top down view of the ball with maze piece axis and ball again for reference; and

FIG. 8 illustrates the tennis balls and the maze apertures.

### DETAILED DESCRIPTION, INCLUDING BEST MODES OF CARRYING OUT THE INVENTION

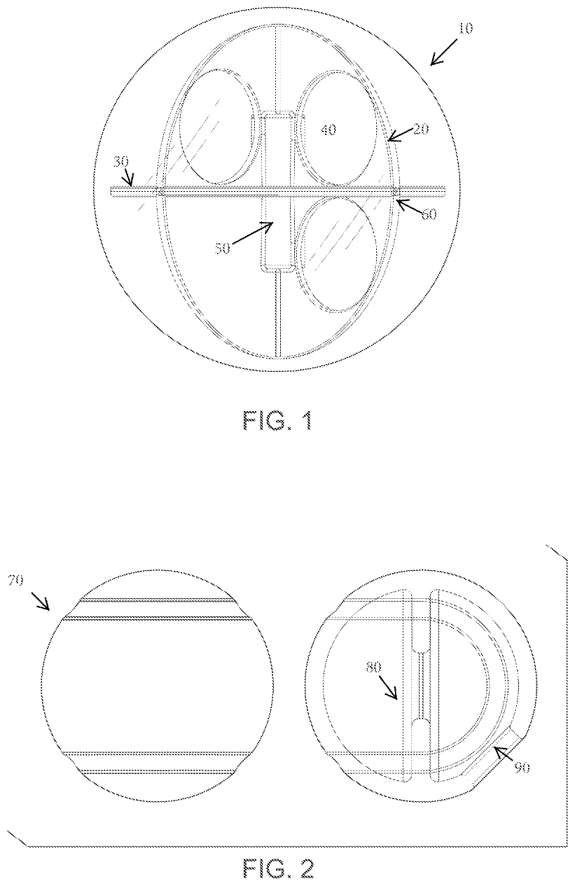

FIG. 1 shows the entire ball with the outer piece 10 which is clear TPE. Inside the “back” maze piece 20 is shown on its axis with a side view of the front maze piece 30 showing just a slice of that maze piece. The apertures for the balls 40 are shown on this maze piece. The two maze pieces are heat welded together with the giggler housing 50 center shafted, but the pieces can move and rotate within the clear out ball when manipulated by the pet. Welded sections of the maze pieces are shown at 60.

FIG. 2 illustrates the tennis ball 70 exterior while the phantom view shows two halves of the interior treat cavity. Treat wall “front” 80 is heat welded to treat wall back inside the tennis ball and an aperture 90 for inserting and removing treats is part of the treat wall back section. Here treats can freely travel out of the tennis ball and into the entire ball to cause audible and olfactory stimulation.

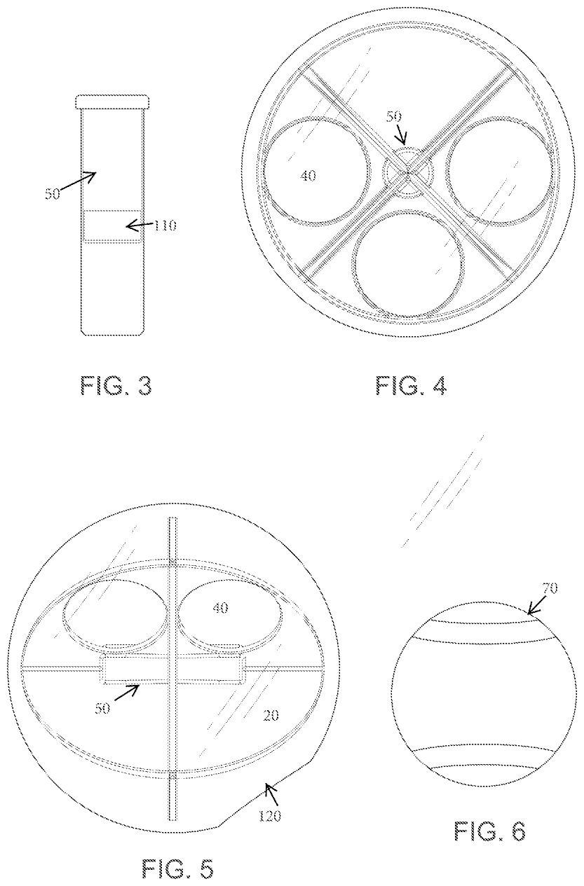

FIG. 3 is the “giggler” housing 50 which is molded into the axis of the treat maze sections. Here, it is shown separate. The giggler will not move from the treat maze sections, but the noisemaker 110 inside the giggler apparatus is shown in phantom as will be allowed to travel freely within the giggler housing so when shaken, and the internal giggler apparatus with travel up and down inside its housing and make the “giggling” sound.

FIG. 4 is top-down view of a maze piece and the giggler housing 50 as is heat molded into the center shaft of the connected maze pieces, and does not move. Ball apertures 40 are again shown.

FIG. 5 again illustrates the back maze section 20 with ball apertures 40. This FIG. provides a side perspective of the giggler housing 50 as affixed to the mase sections.

FIG. 6 is a simple ball 70 illustration for clarity and consistency of size relationships to the apertures within the toy.

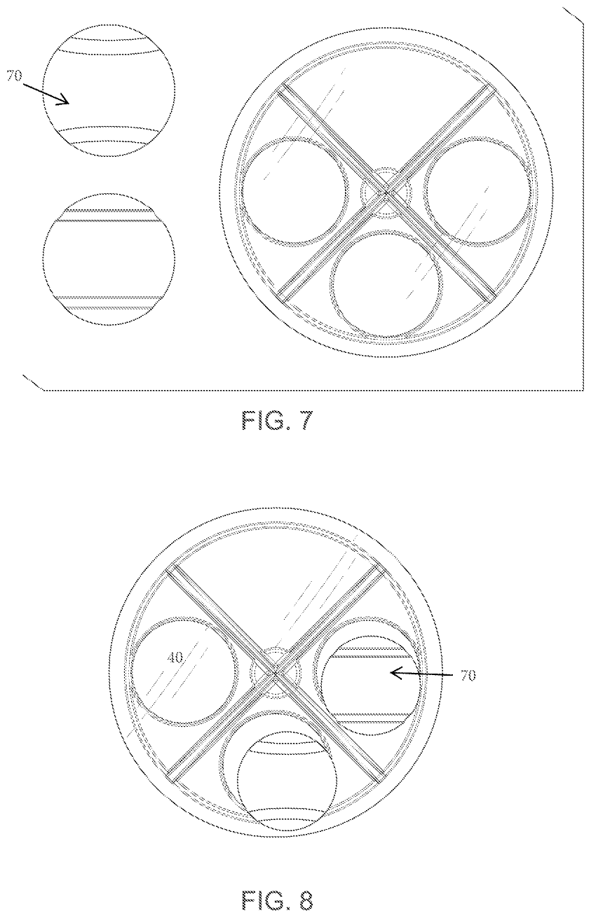

FIG. 7 illustrates the front maze section with ball apertures 40 and the axis and giggler housing 50.

FIG. 8 demonstrates the balls 70 as they can travel through the maze sections apertures 40. It is important to note that the maze sections themselves can keep balls from becoming stuck within the toy. Ideally one would use one or two balls.

1) A pet toy comprising:
a) A hollow clear TPE outer round ball;
b) Sonic welded treat maze front and back sections located within the outer ball with apertures in the sections allowing travel of tennis balls therethrough;
c) Treat maze sections heat welded on an x axis to also encompass a hollow tube with a giggling noisemaker therein centered on an x axis shaft created by treat maze sections;
d) Hollow tennis balls with two-sided sections heat welded to one another within and a single opening for treats;
e) A single opening in the clear outer ball to allow insert and removal of balls; and
f) A welded set of treat maze sections that are affixed to one another, so as to hold the treat maze sections together.

2) A pet toy as in claim 1 wherein a clear outer ball encasing welded sets of treat mazes affixed to one another by heat weld but can travel slightly within the outer section, but not disconnect from one another at any point.

3) A pet toy as in claim 1 wherein one of each of a front section and back section are sonic welded together on an x axis and located inside the clear outer ball and wherein a total of 3 ball apertures are created in the sections to allow travel of inserted tennis balls throughout the outer ball shell.

4) A pet toy as in claim 1 wherein the front and back treat maze sections are sonic welded together and to a hollow tube with a giggling device contained therein which now form part of the shaft in which the treat maze sections are affixed.

5) A pet toy as in claim 1 wherein tennis balls are hollow with exception of a front and back section of open ball and wherein the two internal sections are heat welded together to form a dual chamber and include a single opening for treats to be inserted into the balls, and wherein such treats may circulate through the tennis ball as well as empty into the hollow outer ball.

6) A pet toy as in claim 1 wherein the outer clear ball contains only one opening for a tennis ball or balls to be inserted and removed therefrom.
